(19) United States
(12) Patent Application Publication
(10) Pub. No.: US 2004/0175976 A1
(43) Pub. Date: Sep. 9, 2004

(54) Card type USB connector, and USB gender changer and USB memory card using the card type USB connector

(75) Inventor: Hyoung-jun Park, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/781,907

(22) Filed: Feb. 20, 2004

(30) Foreign Application Priority Data
Feb. 20, 2003 (KR) 10-2003-0010578

(51) Int. Cl. H01R 29/00

(52) U.S. Cl. 439/176

(57) ABSTRACT

A card type USB (Universal Serial Bus) connector, and a USB gender changer and a USB memory card using the card type USB connector. The connector includes a card type plug having a plug body and a plurality of pins on a top of the plug body and a card type receptacle having a receptacle body receiving the card type plug therein. A plurality of pins inside the receptacle body are disposed in correspondence to the plurality of pins of the card type plug so as to be electrically connected. Accordingly, the plurality of pins of the card type plug and the plurality of pins of the card type receptacle are electrically turned on or off according to contact of the plug body to the receptacle body or detachment of the plug body from the receptacle body.

### BACKGROUND OF THE INVENTION

This application claims the priority of Korean Patent Application No. 10-2003-0010578 filed on Feb. 20, 2003, in the Korean Intellectual Property Office, the disclosure of which is incorporated herein by reference.

1. Field of the Invention

The present invention relates generally to a card type USB (Universal Serial Bus) connector, and a USB gender changer and a USB memory card using the card type USB connector, wherein the card type USB connector allows an external device employing the card type USB connector not to be exposed outside of a main device when it is combined with the main device, by providing a card type plug or receptacle, the USB gender changer changes a shape of the card type USB connector so as to be used adaptively in related art plugs or receptacles, and the USB memory card provides the most popular USB interface by applying the card type USB connector thereto and, at the same time, allows the USB memory card not to be exposed outside the main device because it is received in the main device.

2. Description of the Related Art

Currently, we have enjoyed a good number of and a variety of benefits resulting from development of computer and digital technologies. Practically, we live in our daily lives with the use of personal computers, digital cameras, personal digital assistants (PDAs), electronic pocket books, cellular phones, and other kinds of digital devices, which serve to make our lives become more convenient and comfortable.

In order to supplement one or more new functions to these digital devices or enhance their capabilities, they need to interface with a variety of external devices such as an external memory, a local area network (LAN) card, a wireless modem, and so on. In this regard, a variety of interfacing methods have been employed. For example, such digital devices as PDA or digital camera use a memory card as an external storage device. To interface with the memory card, connectors having specifications of MMC/SD (Multimedia Card/Secure Digital), CF (Compact Flash), SMC (Smart Media Card) or MS (Memory Stick), etc. are currently being used.

Referring to FIG. 1, a stick type storage medium employing a related art connector of MMC/SD, CF, SMC or MS specification, etc. will be described briefly. For MMC or CF memory cards, if their respective host controller modules request data, a memory controller among the memory elements within each memory card reads out the data stored in the memory by byte as predetermined, for example, by page of 256 byte or 512 byte, through a buffer, converts them into formats adaptive to each interface with the MMC interface part or ATA interface part and transmits them to their respective host controller.

The memory cards employing connectors of related art specifications are advantageous in that they are small in size and they can be used in a convenient manner. However, they are not compatible with other memory cards of different specifications. In most cases, it is not possible to read and write information stored on a memory card using personal computers (PC) alone by interfacing with the memory card. Therefore, in order to read or write information stored in the memory card through the personal computers, a converter exclusive for reading and writing, containing a controller meeting each memory specification, is required.

To solve problems involved in interfacing digital devices with external devices, attempts to integrate a variety of interfaces have recently been made. A USB mode can be referred to as a typical integrated interface mode.

For an interface of the USB mode, a connector (series “A” or “B” connector) as shown in FIG. 2 has been used. As a stick type storage medium employing this connector, there is USB stick type storage medium such as ThumbDrive™ of TREK Technology. With this device, the user can use an external device by connecting it directly to a digital device such as a personal computer. For example, the stick type storage medium storing therein information generated in the above-described devices can read out or erase the information through any personal computer supporting the USB interface.

However, these devices supporting the USB interface still have some problems. Specifically, related art memory cards are convenient in that they can be used as they are inserted directly into digital devices; but, in order to use the USB memory stick, it has to be connected to an external port of the digital device. In this regard, it is somewhat inconvenient to use the digital device as being connected to the memory stick. Also, because the memory stick is connected to the outer face of the digital device, it is not convenient to carry it.

### SUMMARY OF THE INVENTION

Accordingly, the present invention has been made keeping in mind the above problems occurring in the related art, and an object of the present invention is to provide a card type USB connector making a USB interface with which an external device is allowed to be received within the main device.

A further object of the present invention is to provide a USB gender changer allowing the new card type USB connector to be compatible with related art USB connectors.

Another object of the present invention is to provide a USB memory card employing the new card type USB connector.

These and other objects and features of the present invention will be established as disclosed below, and be appreciated through exemplary embodiments of the present invention.

In order to accomplish the above and other objects of the present invention, there is provided a card type USB connector, comprising a card type plug having a plug body and a plurality of pins on the top of the plug body, a card type receptacle having a receptacle body receiving the card type plug therein, and a plurality of pins inside the receptacle body, the plurality of pins being disposed in correspondence to the plurality of pins of the card type plug so as to be electrically connected, wherein the plurality of pins of the card type plug and the plurality of pins of the card type receptacle are electrically turned on or off according to contact of the plug body to the receptacle body or detachment of the plug body from the receptacle body.

In an exemplary embodiment, the card type plug and the card type receptacle are shaped as a polygon, such as a rectangle.

Also, the card type plug may have guide projections to block a reverse insertion thereof on sides of the plug body, and the card type receptacle body may have holes inside thereof, corresponding to the guide projections.

According to one embodiment of the present invention, there is provided a card type USB gender changer, comprising a card type receptacle composed of a receptacle body receiving therein a card type plug having a plurality of pins on the top of a plug body and a plurality of pins inside the receptacle body, being disposed in correspondence to the plurality of pins of the card type plug so as to allow them to be electrically connected, and a USB plug connected to the receptacle body, having a plurality of pins electrically connected to the plurality of pins of the card type receptacle.

In this embodiment, the USB plug may be series “A” or “B.”

Also, the card type plug may have guide projections to block a reverse insertion of the plug, on sides of the plug body, and holes corresponding to the guide projections are positioned inside the card type receptacle body.

According to one embodiment of the present invention, there is provided a USB gender changer, comprising a card type plug having a plug body and a plurality of pins on the top of the plug body, and a USB receptacle connected to the plug body, having a plurality of pins electrically connected to the plurality of pins of the card type plug.

In this embodiment, the USB receptacle may be series “A” or “B.”

Also, the card type plug may have guide projections to block a reverse insertion of the plug, on sides of the plug body.

According to one embodiment of the present invention, there is provided a USB memory card, comprising a memory storing data therein, a memory controller electrically connected to the memory, storing data in the memory or reading out the data stored in the memory, a USB interface controller electrically connected to the memory controller, converting data received from the memory controller into the date adaptive to USB interface specification so as to output them, receiving the data adaptive to USB interface specification, converting them into the data adaptive to the memory controller specification and outputting them to the memory controller, and a plug body receiving therein the memory, the memory controller and the USB interface controller, wherein a plurality of pins are formed on the top of the plug body.

In an exemplary embodiment, the plug body is shaped as a polygon, such as a rectangle.

Also, the plug body has guide projections to block a reverse insertion of the plug, on sides thereof.

The USB memory card may further comprise a NO WRITE switch to block writing, blocking to write information in the memory or deleting the information stored in the memory.

Also, the memory may comprise a NAND flash memory.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic diagram of a related art MMC/CF type memory card;

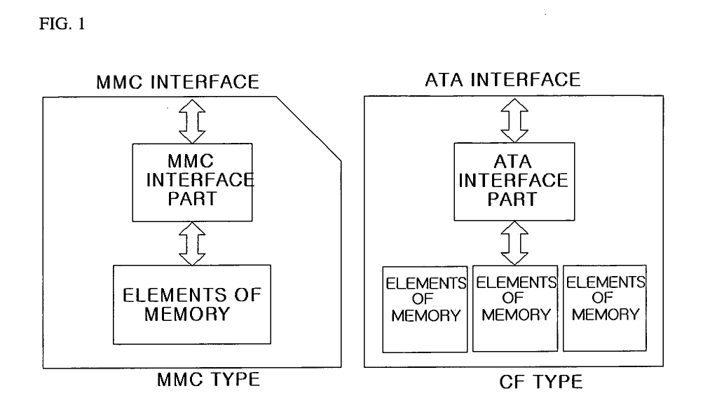

FIG. 2 is a reference view illustrating a related art USB connector;

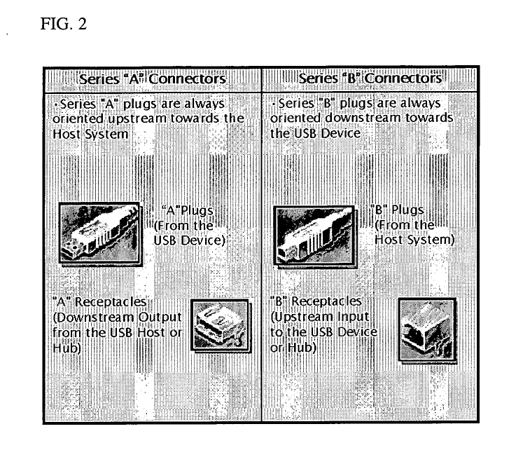

FIG. 3 is a perspective view of a card type USB receptacle according to one embodiment of the present invention;

FIG. 4 is a schematic diagram of a card type USB plug according to one embodiment of the present invention;

FIG. 5 is a schematic diagram of a card type/series “A” gender changer according to one embodiment of the present invention;

FIG. 6 is a schematic diagram of a series “A”/card type gender changer according to another embodiment of the present invention;

FIG. 7 is a schematic diagram showing an external appearance of the USB memory card according to one embodiment of the present invention;

FIG. 8 is a block diagram showing an internal structure of the USB memory card according to one embodiment of the present invention; and

FIG. 9 is a block diagram showing a detailed configuration of a related art memory device.

### DETAILED DESCRIPTION OF THE INVENTION

Reference now will be made to the drawings, in which the same reference numerals are used throughout the different drawings to designate the same or similar components.

A card type USB connector according to the present invention comprises a card type receptacle and a card type plug coupled detachably to the receptacle.

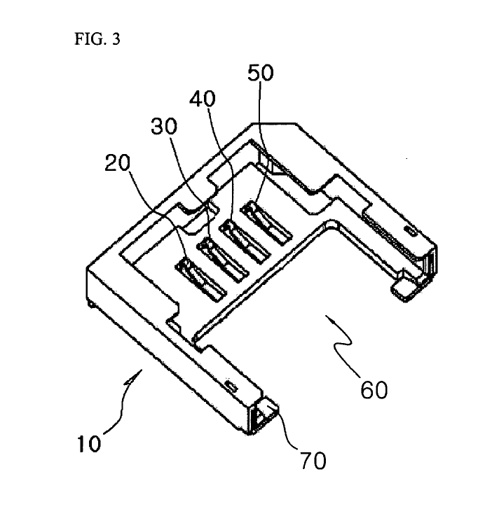

Referring to FIG. 3 which is a perspective view of a card type USB receptacle according to one embodiment of the present invention, the card type USB receptacle comprises a receptacle body 10 and a plurality of receptacle pins (20, 30, 40, and 50).

The receptacle body 10 has an inlet on one end thereof, through which the card type plug to be described later can be inserted to be coupled thereto. The receptacle body 10 in this non-limiting embodiment is shaped like a polygon, preferably a rectangle, whose top may be closed or opened. Guide holes 70 to block a reverse insertion of the card type plug are formed inside the receptacle body 10, preferably along inner walls in both sides thereof, in correspondence to guide projections 160 of the card type plug to be described later.

The plurality of receptacle pins are provided on the inside bottom of the receptacle body 10, although the receptacle pins may be placed elsewhere on the receptacle. In an exemplary embodiment such as shown, there are four receptacle pins such as first and fourth receptacle pins 20 and 50 for voltage supply (Vbus) and ground (GND), and second and third receptacle pins 30 and 40 for data transmission and reception (D-, D+). The receptacle pins 20, 30, 40 and 50 are made of elastic materials having a predetermined power of elasticity, thereby allowing them to electrically contact the plug pins 120, 130, 140 and 150 of the card type USB plug to be described and shown later.

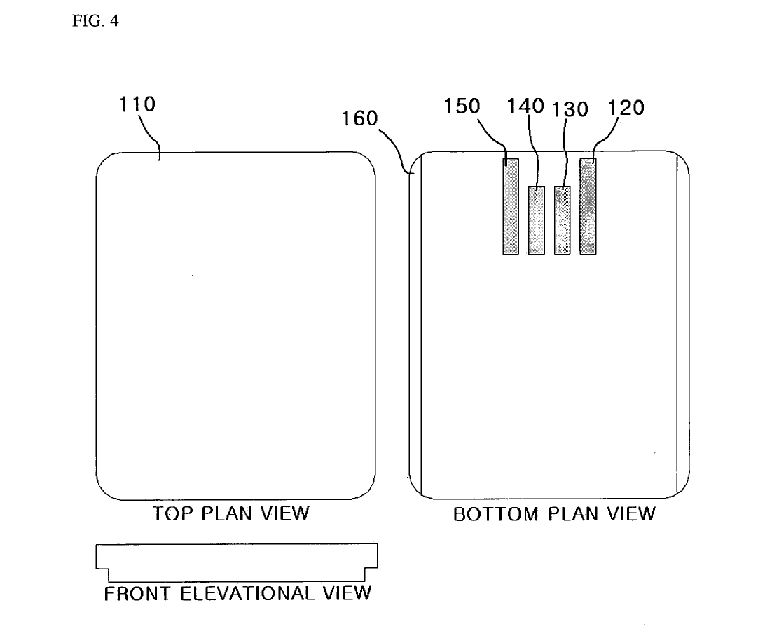

Referring to FIG. 4 which is a schematic diagram of a card type USB plug according to one embodiment of the present invention, the card type USB plug comprises a plug body 110 and a plurality of plug pins (120, 130, 140, and 150).

The plug body 110 takes a shape of a card type polygon, such as a rectangle, which is so thin as to allow it to be inserted into the receptacle body 10. Guide projections 160 to block a reverse insertion of the plug body 110 are formed in a lengthwise direction on the outer surface of the plug body 110, preferably along both sides thereof, in correspondence to the guide holes 70 of the receptacle body 10.

The plurality of plug pins (120 through 150) are positioned, in this embodiment, in front of the top or bottom of the plug body 110. Four receptacle pins such as first and fourth receptacle pins 120 and 150 for voltage supply (Vbus) and ground (GND), and second and third receptacle pins 130 and 140 for data transmission and reception (D−, D+) are disposed oppositely to the plurality of receptacle pins 20, 30, 40 and 50 of the card type USB receptacle when the plug body is inserted and coupled to the receptacle body 10, thereby facilitating electric connection with them. Especially, the first and the fourth plug pins 120 and 150 are formed more ahead in a lengthwise direction than the second and the third plug pins 130 and 140, for which voltage is first supplied to the card type plug when it is inserted and coupled to the card type USB receptacle, and mutual data exchange is made between them due to the supplied voltage.

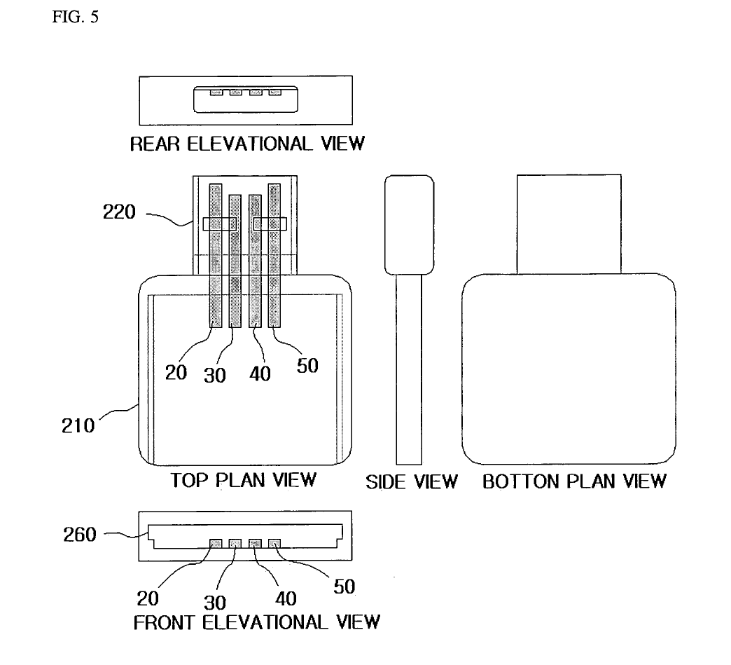

FIG. 5 is a schematic diagram of a card type/series “A” gender changer according to one embodiment of the present invention. As illustrated, a USB gender changer (from card type to series “A”) receiving therein the card type USB plug and being connected to the series “A” receptacle comprises a card type USB receptacle 210 and a USB plug 220, wherein the USB plug 220 is classified into series “A” or series “B” which can be detachably used in related art series “A” or “B” receptacles. Since they employ the same applications, only the series “A” will be described as a way of example for the sake of description.

The card type USB receptacle 210 comprises a receptacle body and a plurality of receptacle pins 20, 30, 40 and 50. The receptacle body and the plurality of receptacle pins 20, 30, 40 and 50 are of the same as those described above, and thus, description thereof will be omitted.

The series “A” USB plug 220 is coupled to the front of the receptacle body integrally or detachably, having a plurality of pins inside thereof so as to allow them to be electrically connected to the plurality of receptacle pins of the card type USB receptacle 210.

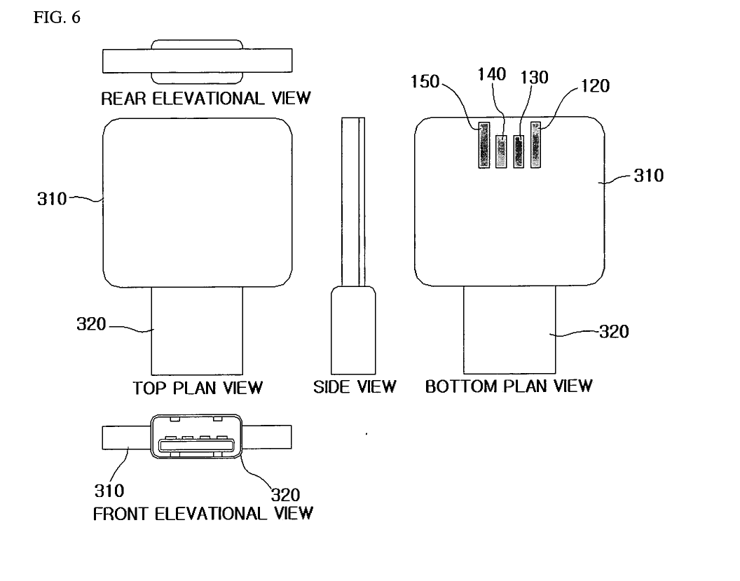

FIG. 6 is a schematic diagram of a series “A”/card type gender changer according to another embodiment of the present invention. As illustrated therein, the USB gender changer (from series “A” to card type) receiving the series “A” USB plug and being connected to the card type receptacle comprises a card type USB plug 310 and a USB receptacle 320. The USB receptacle 320 is classified into series “A” or “B” which can be used in the related art series “A” or “B” plug in an detachable manner. Since they employ the same applications, only the series “A” will be described as a way of example for the sake of description.

The card type USB plug 310 comprises a plug body and a plurality of plug pins 120, 130, 140 and 150. The plug body and the plurality of plug pins 120, 130, 140 and 150 are of the same as those described above, and thus, description thereof will be omitted.

The series “A” USB plug 310 is coupled to the rear of the receptacle 320 integrally or detachably, having a plurality of pins inside thereof so as to allow them to be electrically connected to the plurality of plug pins of the card type USB plug 310.

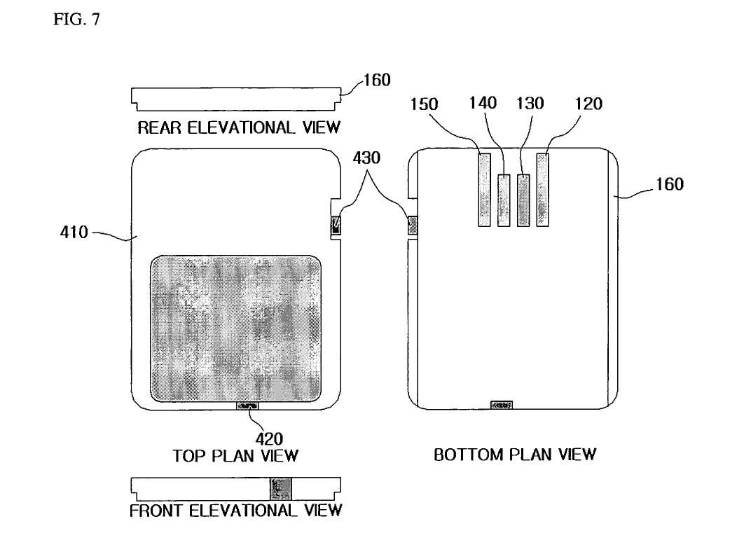

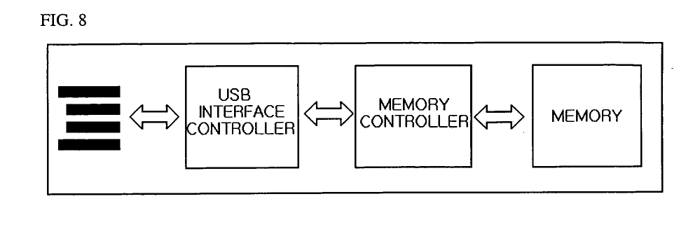

FIGS. 7 and 8 are views showing a USB memory card according to the present invention, wherein FIG. 7 is a schematic diagram showing an external appearance of the USB memory card, and FIG. 8 is a block diagram showing briefly an internal structure of the USB memory card.

As shown in these figures, the USB memory card of the present invention comprises a card type plug body 410 receiving therein a memory, a memory controller and a USB interface controller, and a plurality of plug pins 120, 130, 140 and 150 provided in front of the top or bottom of the plug body 410. The plug body and the plug pins herein are of the same in structure as those described in the previous embodiments, and thus, description thereof will be omitted. However, it should be noted that a NO WRITE switch 430 to block writing may be provided in one side of the plug body, and thus, the user is not allowed to write any information in the memory or delete the information stored in the memory. Also, an LED 420 to indicate an operation may be provided on one side, preferably one side of the rear, of the plug body 410 in this embodiment, wherein an operation status of the memory card is indicated thereon by the voltage supplied through the first and the fourth plug pins 120 and 150.

The memory is a medium storing data therein, in one exemplary embodiment comprising a NAND flash memory.

The memory controller is electrically connected to the memory, storing data in the memory or reading out the data stored in the memory.

The USB interface controller is electrically connected to the memory controller. The USB interface controller converts the data received from the memory controller into the data adaptive to the USB interface specification so as to output them, receives the data adaptive to the USB interface specification, converts them into the data adaptive to the memory controller specification and then outputs them to the memory controller.

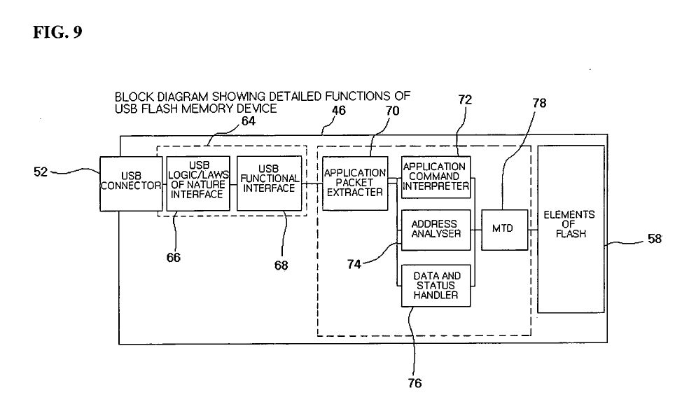

The detailed construction of the USB memory device described above has been disclosed in Korean Patent Laying-Open No. 10-2001-0071332 corresponding to PCT/US2000/07087 titled “Architecture for a universal serial bus-based PC flash disk.” Accordingly, the configuration of the related art USB memory is shown in FIG. 9, but detailed description thereof will be omitted.

The USB memory card, the card type USB connector and the gender changer for the USB memory card according to the present invention have been described in reference to the figures as shown herein. However, the present invention shall not be limited by the descriptions and drawings disclosed in this specification.

The present invention provides a card type USB connector, a USB memory card satisfying the card type USB connector specification, and a gender changer allowing the card type USB connector to be compatible with a conventional USB connector.

In digital devices employing the card type USB connector according to the present invention, input and output ports and card slots for communication with external devices can be integrated into a card type USB receptacle, and thus, portable devices can be used in a more convenient manner in space utilization.

The external device employing the card type USB connector according to the present invention is coupled to a main device and a USB interface and at the same time is received in the main device, and thus, the space utilization is increased and a stability relative to an external impact is increased.

The USB gender changer according to the present invention facilitates mutual compatibility between the card type USB connector according to the present invention and other devices employing conventional USB connectors.

The memory card to which the card type USB connector according to the present invention is applied is received within a main device simultaneously as it provides a USB interface, as the most universal interface, thereby enhancing the space utility and the stability relative to external impact. Especially, where the main device is a portable device, the portability of the main device will increase since the memory card is received within the portable device.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A card type USB connector, comprising:
a card type plug having a plug body and a plurality of pins on a top of the plug body;
a card type receptacle having a receptacle body receiving the card type plug therein, and a plurality of pins inside the receptacle body, the plurality of receptacle pins being disposed in correspondence to the plurality of pins of the card type plug so as to be electrically connected,
wherein the plurality of pins of the card type plug and the plurality of pins of the card type receptacle are electrically turned on or off according to contact of the plug body to the receptacle body or detachment of the plug body from the receptacle body.

2. The card type USB connector as claimed in claim 1, wherein the card type plug and the card type receptacle are polygonal in shape.

3. The card type USB connector as claimed in claim 1, wherein the card type plug has guide projections on sides of the plug body to block a reverse insertion of the card type plug into the receptacle, and the card type receptacle body has holes inside thereof, corresponding to the guide projections.

4. A card type USB gender changer, comprising:
a card type receptacle including a receptacle body receiving therein on one side a card type plug having a plug body and a plurality of pins on a top of the plug body, wherein the receptacle body includes a plurality of pins inside the receptacle body, a first portion of those pins disposed in correspondence to the plurality of pins of the card type plug so as to allow the card type receptacle and the card type plug to be electrically connected; and
a USB plug connected to the receptacle body, having a plurality of pins electrically connected to a second portion of the plurality of pins of the card type receptacle.

5. The USB gender changer as claimed in claim 4, wherein the USB plug is series “A” or “B.”

6. The USB gender changer as claimed in claim 4, wherein the card type plug has guide projections on sides of the plug body to block a reverse insertion of the plug, and holes corresponding to the guide projections are positioned inside the card type receptacle body.

7. A USB gender changer, comprising:
a card type plug having a plug body and a plurality of pins on a top of the plug body; and
a USB receptacle connected to the plug body, having a plurality of pins electrically connected to the plurality of pins of the card type plug.

8. The USB gender changer as claimed in claim 7, wherein the USB receptacle is series “A” or “B.”

9. The USB gender changer as claimed in claim 7, wherein the card type plug has guide projections on sides of the plug body to block a reverse insertion of the plug.

10. A USB memory card, comprising:
a memory storing data therein;
a memory controller electrically connected to the memory, controlling storage of data in the memory or reading out the data stored in the memory;
a USB interface controller electrically connected to the memory controller, for converting data from the memory controller into data adaptive to a USB interface specification for output, and for converting data received from a device adapted to the USB interface specification into data adaptive to the memory controller specification; and
a plug body receiving therein the memory, the memory controller and the USB interface controller,
wherein a plurality of pins are formed on the top of the plug body for electrically connecting the USB memory card.

11. The USB memory card as claimed in claim 10, wherein the plug body is polygonal in shape.

12. The USB memory card as claimed in claim 10, wherein the plug body has guide projections to block a reverse insertion of the plug, on sides thereof.

13. The USB memory card as claimed in claim 10, further comprising a NO WRITE switch to block writing of information in the memory or deletion of information stored in the memory.

14. The USB memory card as claimed in claim 10, wherein the memory comprises a NAND flash memory.
